(19) United States
(12) Patent Application Publication
(10) Pub. No.: US 2012/0284428 A1
(43) Pub. Date: Nov. 8, 2012

(54) ELECTRONIC DEVICE HAVING AUDIO PORTS

(75) Inventors: ZHENG-HENG SUN, Tu-Cheng (TW); KANG WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/246,872

(22) Filed: Sep. 28, 2011

(30) Foreign Application Priority Data
May 6, 2011 (CN) 201110116712.6

(51) Int. Cl. G06F 3/00

(52) U.S. Cl. 710/3

(57) ABSTRACT

An electronic device includes an audio port, a route selection unit, and an identification unit. The audio port may be electronically connected to a computer peripheral apparatus having a plug. The identification unit identifies the computer peripheral apparatus and then sends a control command to the route selection unit. The route selection unit provides a first data transmission route to the computer peripheral apparatus according to the control command, so that the electronic device can communicate with the computer peripheral apparatus.

### BACKGROUND

1. Technical field

The disclosure generally relates to electronic devices, particularly to an electronic device having audio ports.

2. Description of the Related Art

Many electronic devices, such as notebook computers, only have two universal serial bus (USB) ports and two audio ports. However, a keyboard or a mouse will occupy at least one USB port. Thus, there are an insufficient number of USB ports. On the other hand, the audio ports remain idle when an earphone or a microphone is not in use, and the inability of the keyboard or the mouse to communicate with the notebook computer via the audio ports is a disadvantage.

Therefore, there is room for improvement within the art.

### BRIEF DESCRIPTION OF THE DRAWINGS

Many aspects of an exemplary electronic device can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views. Wherever possible, the same reference numbers are used throughout the drawings to refer to the same or like elements of an embodiment.

FIG. 1 is a view of an electronic device, according to an exemplary embodiment.

FIG. 2 is a view of the electronic device in communication with a mouse as shown in FIG. 1.

FIG. 3 is an enlarged view of the area III as shown in FIG. 1.

FIG. 4 is a block diagram of the electronic device as shown in FIG. 1.

### DETAILED DESCRIPTION

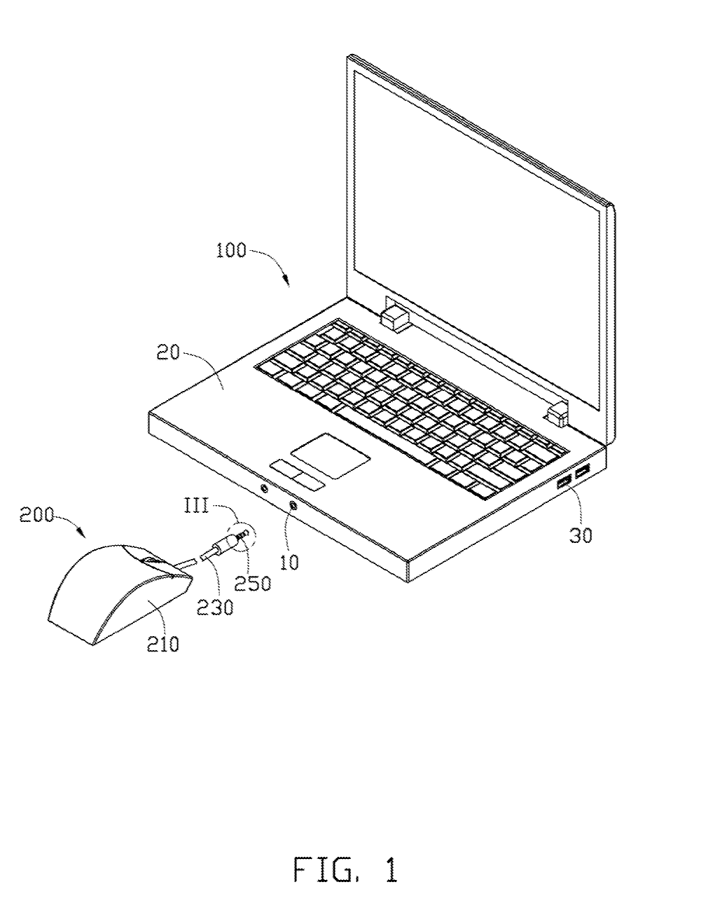

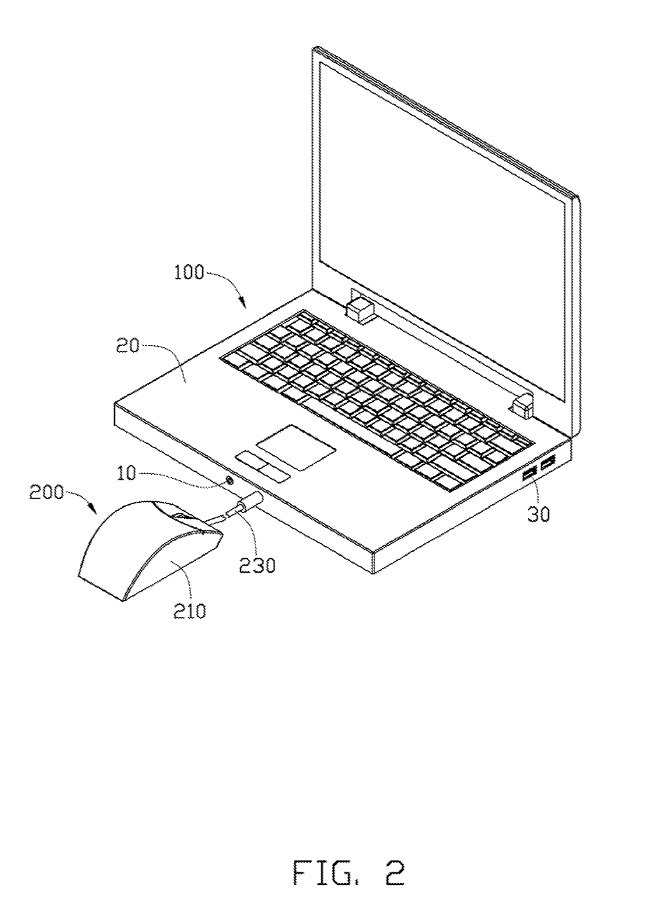

FIGS. 1-2 show an electronic device 100, according to an exemplary embodiment. The electronic device 100 can be a notebook computer, a desktop computer, or any other electronic apparatus that has at least one audio port 10. The electronic device 100 is operable to communicate with a computer peripheral apparatus via the at least one audio port 10.

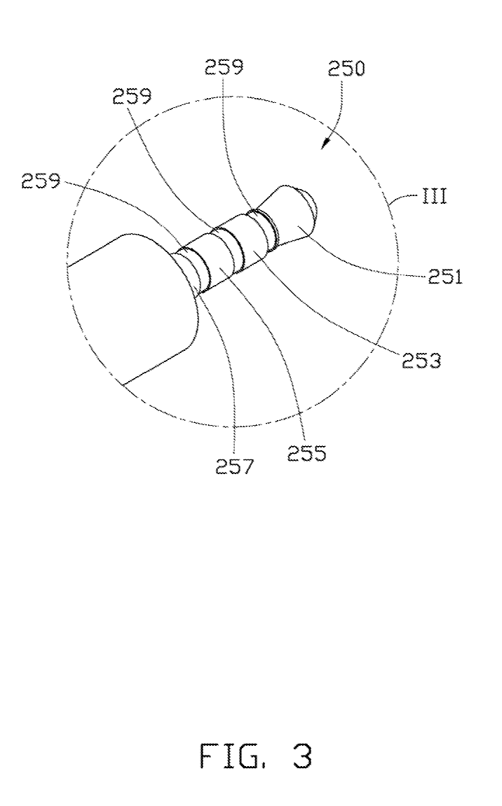

In one non-limiting example, the computer peripheral apparatus can be a keyboard or a mouse. In one exemplary embodiment, the computer peripheral apparatus is a mouse 200. The mouse 200 includes a body 210, a cable 230, and a plug 250. The body 210 includes a plurality of electronic components therein for cooperatively outputting operation commands, such as a double-click. The cable 230 connects the body 210 to the plug 250. Referring to FIG. 3, the plug 250 is a four-pole plug, and is divided into a first section 251, a second section 253, a third section 255, and a fourth section 257 by three insulation rings 259. The first section 251, the second section 253, the third section 255, and the fourth section 257 are respectively connected to a signal wire, which is shielded and surrounded by the cable 230. The first section 251 is operable to transmit data signals, the second section 253 is operable to transmit clock signals. The third section 255 is connected to ground, and the fourth section obtains power to power the mouse 200.

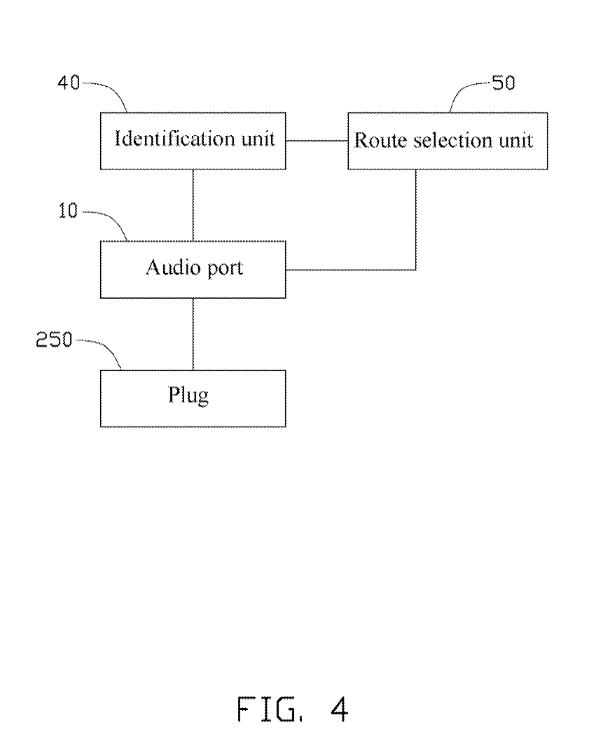

Referring to FIG. 4, the electronic device 100 further includes a housing 20, at least one USB port 30, an identification unit 40, and a route selection unit 50. The audio port 10 is positioned at the front side of the housing 20, the identification unit 40 and the route selection unit 50 are both positioned on a motherboard of the electronic device 100.

The audio port 10 can be a microphone port or an earphone port. The audio port 10 defines a plurality of connection pins therein, thus, the mouse 200 can electronically connect physically to the electronic device 100 via the connection pins.

The identification unit 40 is electronically connected to the audio port 10 and the route selection unit 50. In one embodiment, the identification unit 40 can be a voltage detection microchip. According to an audio plug standard, a traditional microphone plug or earphone plug is a three-pole plug, which includes a left channel section, a right channel section, and a ground section. Comparing the plug 250 of the mouse 200 and the microphone plug or earphone plug, the microphone plug or earphone plug does not include a power section, which is equal to the fourth section 257 of the plug 250. Thus, the identification unit 40 can identify the mouse 200 by detecting a voltage of the fourth section 257. In this embodiment, when the mouse 200 is connected to the electronic device 100 via the audio port 10, the fourth section 257 is connected to the connection pin of the audio port 10 to receive a power of about 5V. Thus, the identification unit 40 can identify the mouse 200 according to the voltage of the fourth section 257, and then send a first control command, according to the identification, to the route selection unit 50. However, when the microphone plug or earphone plug is connected to the electronic device 100 via the audio port 10, the identification unit 40 cannot detect a voltage of the microphone plug or earphone plug. Thus, the identification unit 40 identifies the microphone or earphone plug by default, and then sends a second control command to the route selection unit 50.

In one embodiment, the route selection unit 50 can be a multiplexer that provides a communication route to the mouse 200 or to the microphone or earphone according to either the first control command or the second control command. In this embodiment, the communication route includes a first data transmission route for transmitting the operation commands, such as the double-click, of the mouse 200 to the motherboard, and a second data transmission route for transmitting audio signals between the audio ports 10 and an audio input/output (IO) interface of the motherboard. When the route selection unit 50 receives the first control command, the route selection unit 50 provides the first data transmission route for transmitting the operation commands from the audio ports 10 to the motherboard, to process the operation commands Thus, effective communication between the mouse 200 and the electronic device 100 is enabled. When the route selection unit 50 receives the second control command, the route selection unit 50 provides the second data transmission route for transmitting the audio signals between the audio ports 10 and the audio input/output (IO) interface of the motherboard, to process the audio signals. Thus, direct communication between the earphone or microphone and the electronic device 100 is enabled.

The mouse 200 can be connected to the electronic device 100 via the audio port 10 when users do not need to use the microphone or earphone. The fourth section 257 of the plug 250 is electronically connected to the connection pin of the audio port 10 and obtains the power from the electronic device 100. Then, the identification unit 40 detects the voltage of the fourth section 257 through the corresponding connection pin of the audio port 10, and further identifies the mouse 200. Thus, the identification unit 40 sends the first control command to the route selection unit 50, and then the route selection unit 50 provides the first data transmission route so that the mouse 200 can communicate with the electronic device 100.

The electronic device 100 can communicate with the computer peripheral apparatus that has the plug 250 via the audio port 10. Thus, the computer peripheral apparatus would not occupy the USB port 30 of the electronic device 100, and the connection of at least two storage devices via the USB port 30 can be achieved.

Although numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. An electronic device in communication with a computer peripheral apparatus having a plug, the electronic device comprising:
an audio port;
a route selection unit; and
an identification unit electronically connected to the audio port and the route selection unit;
wherein when the audio port is electronically connected to the plug of the computer peripheral apparatus, the identification unit identifies the computer peripheral apparatus, and sends a control command, according to the identification, to the route selection unit, the route selection unit provides a first data transmission route according to the control command, so that the electronic device communicates with the computer peripheral apparatus via the first data transmission route.

2. The electronic device as claimed in claim 1, wherein the identification unit is operable to identify a plug of a microphone or an earphone connected to the audio port, and send another control command to the route selection unit, the route selection unit provides a second data transmission route to the microphone or the earphone.

3. The electronic device as claimed in claim 1, wherein the route selection unit and the identification unit are positioned on a motherboard of the electronic device.

4. The electronic device as claimed in claim 3, wherein the first data transmission route is from the audio port to the motherboard of the electronic device.

5. The electronic device as claimed in claim 1, wherein the route selection unit is a multiplexer.

6. The electronic device as claimed in claim 1, wherein the identification unit is a voltage detection microchip.

7. The electronic device as claimed in claim 1, wherein the computer peripheral apparatus is a mouse.

8. The electronic device as claimed in claim 1, wherein the plug of the computer peripheral apparatus is a four-pole plug.

9. The electronic device as claimed in claim 8, wherein the plug is divided into a first section, a second section, a third section, and a fourth section by three insulation rings.

10. The electronic device as claimed in claim 9, wherein the first section is operable to transmit data signals, the second section is operable to transmit clock signals, the third section is connected to ground, and the fourth section obtains power to power the computer peripheral apparatus.

11. The electronic device as claimed in claim 10, wherein when the plug is connected to the audio port, the fourth section obtains power from the electronic device, and the identification unit detects a voltage of the fourth section to identify the computer peripheral apparatus.

12. The electronic device as claimed in claim 1, wherein the electronic device is a notebook computer.
